(19) United States
(12) Patent Application Publication
(10) Pub. No.: US 2025/0065603 A1
(43) Pub. Date: Feb. 27, 2025

(54) MULTIMATERIAL SHEET

(71) Applicant: SABIC GLOBAL TECHNOLOGIES B.V., Bergen op Zoom (NL)

(72) Inventors: Raj CN Thiagarajan, Bangalore (IN); Christianus Johannes Joacobus Maas, Rilland (NL); Eric Gervais, Maisons Alfort (FR); Alan Powell, Sydney (AU); Tony Bragg, Dee Why (AU)

(21) Appl. No.: 18/721,424

(22) PCT Filed: Dec. 12, 2022
(86) PCT No.: PCT/IB2022/062491

§ 371 Date: Jun. 18, 2024

(30) Foreign Application Priority Data
Dec. 22, 2021 (IN) 202141059911
Feb. 11, 2022 (EP) 22156250.7

(51) Int. Cl. B32B 9/00; B32B 3/12; B32B 3/30; B32B 7/02; B32B 7/12; B32B 17/10; B32B 27/36; E04C 2/54

(52) U.S. Cl. CPC B32B 9/005; B32B 3/12; B32B 3/30; B32B 7/02; B32B 7/12; B32B 17/10; B32B 27/365; E04C 2/54; B32B 2307/102; B32B 2307/412; B32B 2307/732; B32B 2419/04; B32B 2419/06

(57) ABSTRACT

A multimaterial sheet includes a first layer (10) comprising a first plastic and having a density of 2.000-5.000 kilograms per cubic meter; a second layer (20) comprising a second plastic, glass, ceramic, or a combination thereof and having a density of 800-5,000 kilograms per cubic meter, wherein the second layer (20) is spaced apart (15) from the first layer (10); a third layer (30) comprising a multiwall sheet and having a density of 50-250 kilograms per cubic meter, or 60-200 kilograms per cubic meter; and a fourth layer (40) comprising a third plastic and having a density of 800-2.000 kilograms per cubic meter, wherein the first layer, the second layer, the third layer, and the fourth layer are stacked along a y-axis.

### CROSS REFERENCE TO RELATED APPLICATIONS

This application claims priority to Indian Application No. 202141059911, filed on Dec. 22, 2021, and European Application 22156250.7, filed on Feb. 11, 2022, the content of which are incorporated by reference in their entirety.

Disclosed herein are multimaterial sheets, and more particularly sound insulated multimaterial sheets, e.g., for use in glazing and industrial applications.

### BACKGROUND

In the construction of naturally lit structures (e.g., greenhouses, pool enclosures, conservatories, stadiums, sunrooms, and so forth), glass has been employed in many applications as transparent structural elements, such as, windows, facings, and roofs. However, polymer sheeting is replacing glass in many applications due to several notable benefits.

One benefit of polymer sheeting is that it exhibits excellent impact resistance compared to glass. This in turn reduces breakage and hence, maintenance costs in applications wherein vandalism, hail, contraction/expansion, and so forth, is encountered. Another benefit of polymer sheeting is a significant reduction in weight compared to glass. This makes polymer sheeting easier to install than glass and reduces the load-bearing requirements of the structure on which they are installed.

In addition to these benefits, one of the most significant advantages of polymer sheeting is that it provides improved insulative properties compared to glass. This characteristic significantly affects the overall market acceptance of polymer sheeting as consumers desire structural elements with improved efficiency to reduce heating and/or cooling costs. Although the insulative properties of polymer sheeting are greater than that of glass, it is challenging to have a low thermal insulation value, high stiffness (i.e., rigidity), and light transmission in polymer sheeting. Thus, there is a continuous demand for further improvement.

Multiwall sheets are commonly designed for structural and thermal insulation applications. As mentioned, higher thermal insulation values are continually sought in the industry for multiwall sheet applications. Sound pollution is another concern with effective materials for cost effective sound insulation being needed. Increasing the weight of the multiwall sheet is a possibility for increasing sound insulation. However, such an increase in weight is counterproductive to the weight savings utilized by using polymer sheeting compared to glass and adds to the overall cost of the sheeting. Additionally, for applications in which a transparent multiwall sheet is desired, it can be difficult to achieve the desired sound insulation properties of the multiwall sheet without also including the transparency of the multiwall sheet.

Thus, there is a need for multiwall sheets that possess increased sound insulation without a significant increase in weight. There is also a need for increased sound insulation properties with minimal or no impact on the overall transparency of the multiwall sheet.

### SUMMARY

Disclosed, in various aspects, are multimaterial sheets and methods for making and using the same.

In an aspect, a multimaterial sheet includes a first layer (10) including a first plastic and having a density of 2,000-5,000 kilograms per cubic meter (kg/m³); a second layer (20) including a second plastic, glass, ceramic, or a combination thereof and having a density of 800-5,000 kg/m³, wherein the second layer (20) is spaced apart (15) from the first layer (10); a third layer (30) including a multiwall sheet and having a density of 50-250 kg/m³, or 60-200 kg/m³; and a fourth layer (40) including a third plastic and having a density of 800-2,000 kg/m³, wherein the first layer (10), the second layer (20), the third layer (30), and the fourth layer (40) are stacked along a y-axis.

These and other features and characteristics are more particularly described below.

### BRIEF DESCRIPTION OF THE DRAWINGS

The following is a brief description of the drawings wherein like elements are numbered alike and which are presented for the purposes of illustrating the exemplary aspects disclosed herein and not for the purposes of limiting the same.

A more complete understanding of the components, processes, and apparatuses disclosed herein can be obtained by reference to the accompanying drawings. These figures (also referred to herein as “FIG.”) are merely schematic representations based on convenience and the ease of demonstrating the present disclosure, and are, therefore, not intended to indicate relative size and dimensions of the devices or components thereof and/or to define or limit the scope of the exemplary aspects. Although specific terms are used in the following description for the sake of clarity, these terms are intended to refer only to the particular structure of the aspects selected for illustration in the drawings, and are not intended to define or limit the scope of the disclosure.

FIG. 1 is a partial, cross-sectional view of a multimaterial sheet;

FIG. 2 is a graph of Transmission loss (decibels (dB)) and Sound Transmission Loss (STL) (dB) versus Frequency (hertz (Hz)) of Example 1;

FIG. 3 is a partial, cross-sectional view of a multimaterial sheet;

FIG. 4 is a graph of Transmission loss (dB) and STL (dB) versus Frequency (Hz) of Example 2;

FIG. 5 is a partial, cross-sectional view of an aspect of a multiwall sheet;

FIG. 6 is a partial, cross-sectional view of an aspect of a multiwall sheet;

FIG. 7 is a partial, cross-sectional view of an aspect of a multiwall sheet;

FIG. 8 is a partial, cross-sectional view of an aspect of a multiwall sheet;

FIG. 9 is a partial, cross-sectional view of an aspect of a multiwall sheet;

FIG. 10 is a partial, cross-sectional view of an aspect of a multiwall sheet; and

FIG. 11 is a partial, cross-sectional view of an aspect of a multiwall sheet.

### DETAILED DESCRIPTION

Disclosed herein are multimaterial sheets and methods of making the same which include layers of different materials of differing densities. The disclosed multimaterial sheets including layers of different materials of differing densities display a surprisingly high sound transmission loss. Sound pollution is a key concern in certain applications and thus, multimaterial sheets with improved sound transmission losses are needed for sound insulation. A one or two decibel (dB) increase in the sound transmission loss can be considered a significant improvement.

Sound reduction can be achieved either by sound transmission loss or sound attenuation or sound absorption. Without wishing to be bound by theory, it is believed that sound absorption can operate by interacting with the incident sound waves and is mainly a surface interaction phenomenon. Sound is not absorbed effectively with materials such as fiberglass, cellulose, foam, and mineral wool. However, when layers of different materials of differing densities as herein described are used to achieve sound reduction in multimaterial sheets, there is an effective reduction in sound.

Sound insulation or STL is a function of the mass, stiffness, and thickness of a multiwall sheet. STL is quantified by a single number rating such as Sound Transmission Class (STC) or Weighted Sound Reduction Index (Rw). STC is a single number rating specified by ASTM E413, for the frequency range of 125 to 4,000 Hz. Rw is single figure rating specified by ISO 717 and DIN 52210-75, for frequency range of 100 to 3,150 Hz. STC and Rw ratings can be the same or within 1 point, and can be used interchangeably. As used herein, STL can denote both STC and Rw.

The STL/STC/Rw of an acoustic product is determined by comparing a measured or calculated transmission loss curve of the acoustic product with a set of ASTM/ISO standard curves. A standard curve is determined that meets the criteria that the sum of the deviations of the standard and measured/calculated curves is not greater than 32 dB, and according to ISO, deviation at any frequency is not more than 8 dB. The value at 500 Hz of the standard curve that meets the criteria is the single-number quantity STL/STC/Rw rating.

STL can be a function of mass, stiffness, and acoustic damping. The multimaterial sheets disclosed herein offer a system which provides efficient damping and sound insulation. It is believed that the layers of different materials of differing densities resonates and dissipates the sound thereby providing an exceptional sound transmission loss as specified by ASTM E413. Without wishing to be bound by theory, it is believed that the different materials of differing densities of the multiple layers can effectively resonate and dissipate the sound energy in the broad frequency range from 100 to 4,000 Hz.

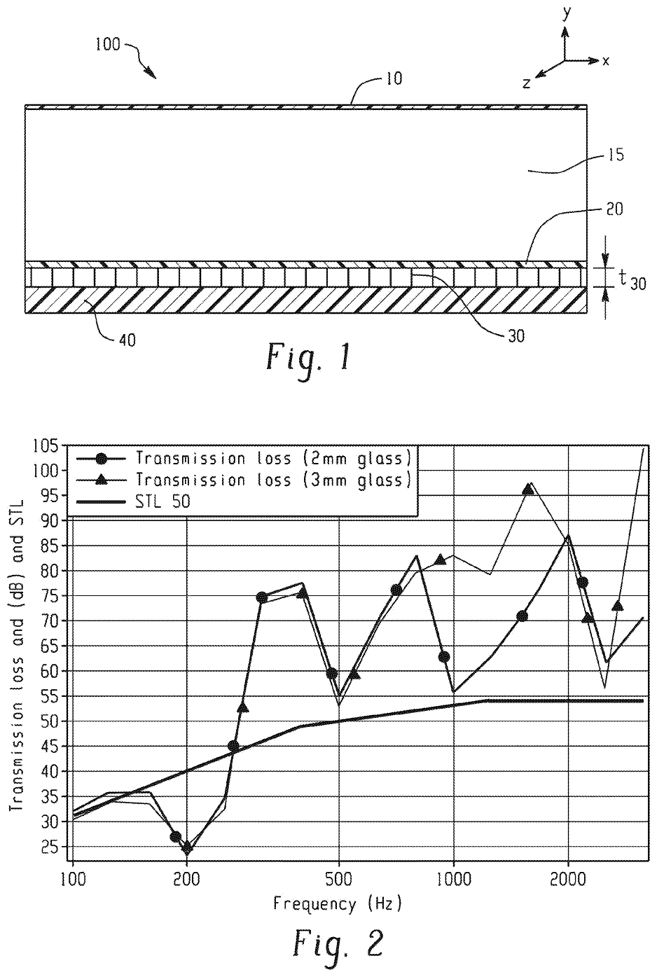

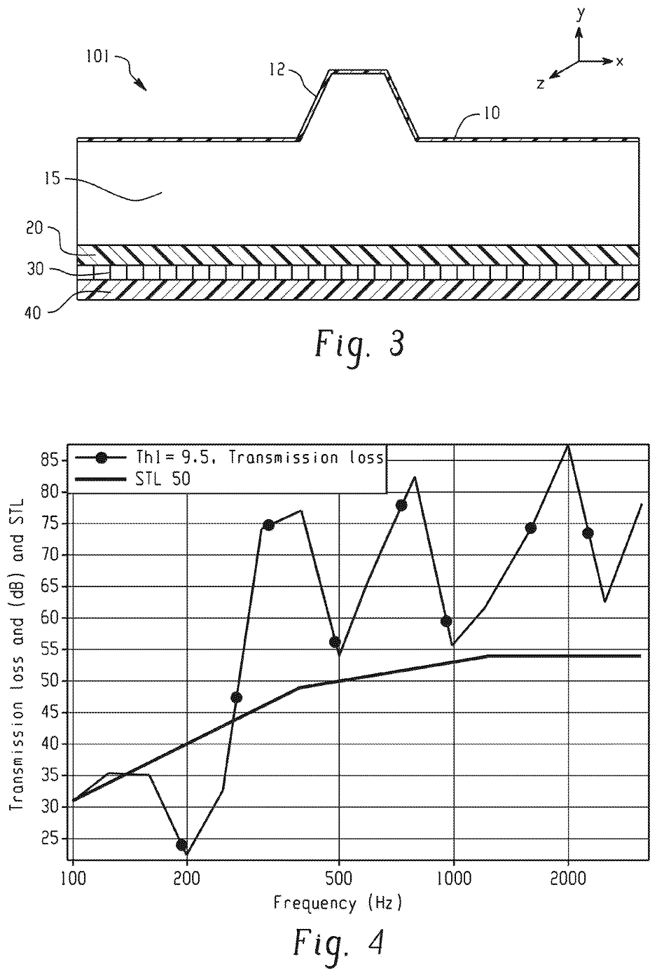

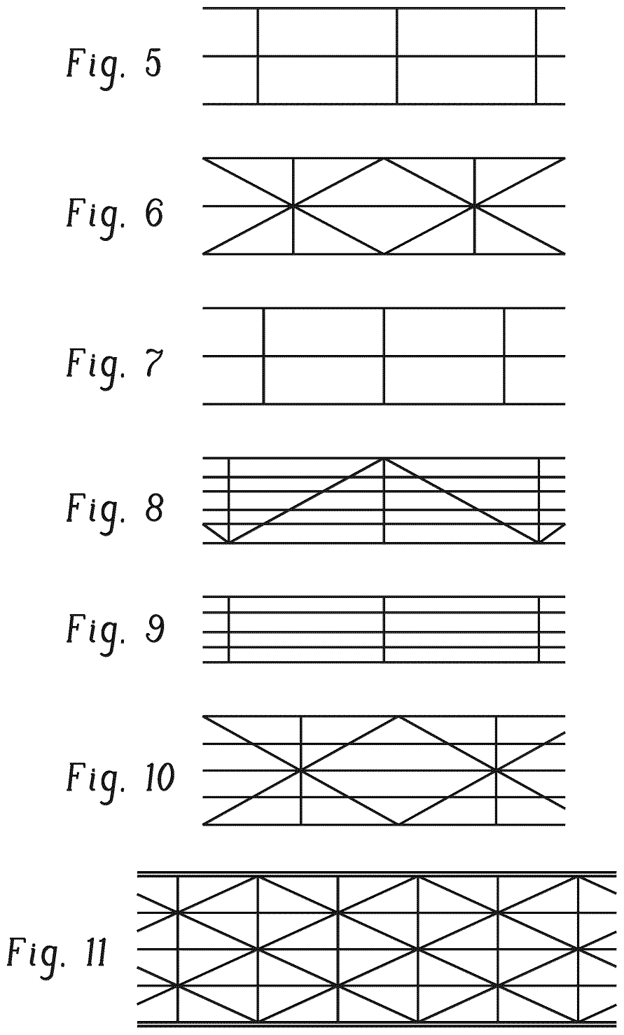

With reference to FIG. 1, the disclosed multimaterial sheet includes a first layer (10) including a first plastic; a second layer (20) including a second plastic, glass, ceramic, or a combination thereof, the second layer (20) being spaced apart (15) from the first layer (10); a third layer (30) including a multiwall sheet; and a fourth layer (40) including a third plastic. As shown in FIG. 1, the first layer (10), the second layer (20), the third layer (30), and the fourth layer (40) are stacked along a y-axis. The first layer (10) has a density of 2,000 to 5,000 kg/m³; the second layer (20) has a density of 800 to 5,000 kg/m³. The third layer (30) has a density of 50 to 250 kg/m³, or 60 to 200 kg/m³; and the fourth layer (40) has a density of 800 to 2,000 kg/m³.

Transmission loss and STL for the multimaterial sheet illustrated in FIG. 1 are provided in Example 1 and FIG. 2. A total thickness of the multimaterial sheet along the y-axis can be 10 to 1,000 millimeters (mm), or 25 to 500 mm, or 50 to 100 mm. A sound transmission loss of the multimaterial sheet can be greater than 50 decibels, or greater than 51 decibels or greater than 52 decibels, for example, as specified by ASTM E413-16.

The disclosed multimaterial sheet can have a transparency of greater than or equal to 50%, for example, greater than or equal to 85%, greater than or equal to 90%, greater than or equal to 95%, greater than or equal to 96%, or greater than or equal to 99%.

Percent transmission for laboratory scale samples can be determined using ASTM D1003-00, procedure B using CIE standard illuminant C. ASTM D-1003-00 (Procedure B, Spectrophotometer, using illuminant C with diffuse illumination with unidirectional viewing) defines transmittance as:

$$\% T = ( \frac{I}{{I}_{o}} ) \times 100 \% \qquad ( 2 )$$

wherein: I=intensity of the light passing through the test sample
   Iₒ=Intensity of incident light.

### First Layer

The first layer (10) can have a density of 2,000 to 5,000 kilograms per cubic meter (kg/m³). A thickness of the first layer (10) along the y-axis can be 0.1 to 25 mm, or 1 to 10 mm or 1 to 3 mm.

The first plastic can be a thermoplastic resin, thermoset, or a combination thereof. Possible thermoplastic resins that can be employed include, but are not limited to, oligomers, polymers, ionomers, dendrimers, copolymers such as graft copolymers, block copolymers (e.g., star block copolymers, random copolymers, etc.), or a combination thereof. Examples of such thermoplastic resins include, but are not limited to, polycarbonates (e.g., blends of polycarbonate (such as, polycarbonate-polybutadiene blends, copolyester polycarbonates)), polystyrenes (e.g., copolymers of polycarbonate and styrene, polyphenylene ether-polystyrene blends), polyimides (e.g., polyetherimides), acrylonitrile-styrene-butadiene (ABS), polyalkylmethacrylates (e.g., polymethylmethacrylates), polyesters (e.g., copolyesters, polythioesters), polyolefins (e.g., polypropylenes and polyethylenes, high density polyethylenes, low density polyethylenes, linear low density polyethylenes), polyamides (e.g., polyamideimides), polyarylates, polysulfones (e.g., polyarylsulfones, polysulfonamides), polyphenylene sulfides, polytetrafluoroethylenes, polyethers (e.g., polyether ketones, polyether etherketones, polyethersulfones), polyacrylics, polyacetals, polybenzoxazoles (e.g., polybenzothiazinophenothiazines, polybenzothiazoles), polyoxadiazoles, polypyrazinoquinoxalines, polypyromellitimides, polyquinoxalines, polybenzimidazoles, polyoxindoles, polyoxoisoindolines (e.g., polydioxoisoindolines), polytriazines, polypyridazines, polypiperazines, polypyridines, polypiperidines, polytriazoles, polypyrazoles, polypyrrolidines, polycarboranes, polyoxabicyclononanes, polydibenzofurans, polyphthalides, polyacetals, polyanhydrides, polyvinyls (e.g., polyvinyl ethers, polyvinyl thioethers, polyvinyl alcohols, polyvinyl ketones, polyvinyl halides, polyvinyl nitriles, polyvinyl esters, polyvinylchlorides), polysulfonates, polysulfides, polyureas, polyphosphazenes, polysilazzanes, polysiloxanes, or a combination thereof.

In an aspect, the first plastic can include, but is not limited to, polycarbonate resins (e.g., Lexan* resins, commercially available from SABIC Innovative Plastics), polyphenylene ether-polystyrene resins (e.g., Noryl* resins, commercially available from SABIC Innovative Plastics), polyetherimide resins (e.g., Ultem* resins, commercially available from SABIC Innovative Plastics), polybutylene terephthalate-polycarbonate resins (e.g., Xenoy* resins, commercially available from SABIC Innovative Plastics), copolyestercarbonate resins (e.g. Lexan* SLX resins, commercially available from SABIC Innovative Plastics), or a combination thereof. In an aspect, the thermoplastic resins can include, but are not limited to, homopolymers and copolymers of a polycarbonate, a polyester, a polyacrylate, a polyamide, a polyetherimide, a polyphenylene ether, or a combination thereof. The polycarbonate can include copolymers of polycarbonate (e.g., polycarbonate-polysiloxane, such as polycarbonate-polysiloxane block copolymer), linear polycarbonate, branched polycarbonate, end-capped polycarbonate (e.g., nitrile end-capped polycarbonate), or a combination thereof, for example, a combination of branched and linear polycarbonate.

The first plastic can include various additives ordinarily incorporated into polymer compositions of this type, with the proviso that the additive(s) are selected so as to not significantly adversely affect the desired properties of the first layer, multimaterial sheet, or combination thereof, in particular, sound transmission loss and desired degree of transparency. Such additives can be mixed at a suitable time during the mixing of the components for forming the first layer. Exemplary additives include impact modifiers, fillers, reinforcing agents, antioxidants, heat stabilizers, light stabilizers, ultraviolet (UV) light stabilizers, plasticizers, lubricants, mold release agents, antistatic agents, colorants (such as carbon black and organic dyes), surface effect additives, radiation stabilizers (e.g., infrared absorbing), flame retardants, diffusion barriers (e.g., gas and/or liquid barriers), and anti-drip agents. A combination of additives can be used, for example a combination of a heat stabilizer, mold release agent, and ultraviolet light stabilizer. The additives can be used in the amounts effective for providing the desired property (e.g., UV light stabilizers are effective for filtering UV and protecting the first layer from UV light). The total amount of additives (other than any impact modifier, filler, or reinforcing agents) can be 0.001 wt % to 5 wt %, based on the total weight of the composition of the first layer.

In addition to sound transmission, the plastic material can be chosen to exhibit sufficient impact resistance such that the first layer, multiwall sheet, or combination thereof is capable of resisting breakage (e.g., cracking, fracture, and the like) caused by impact (e.g., hail, birds, stones and so forth). Therefore, plastics exhibiting an impact strength greater than or equal to about 7.5 foot-pounds per square inch (ft-lb/in²) (4.00 Joules per square centimeter (J/cm²)), for example, greater than about 10.0 ft-lb/in² (5.34 J/cm²) or greater than or equal to about 12.5 ft-lb/in² (6.67 J/cm²) are desirable, as tested per ASTM D-256-93 (Izod Notched Impact Test). Further, desirably, the plastic has ample stiffness to allow for the production of a multimaterial sheet that can be employed in applications wherein the multimaterial sheet can be supported and/or clamped on two or more sides of the multimaterial sheet (e.g., clamped on all four sides), such as in greenhouse applications including tubular steel frame construction. Sufficient stiffness herein is defined as polymers having a Young's modulus (e.g., modulus of elasticity) that is greater than or equal to about 1×10⁹ Newtons per square meter (N/m²), for example 1×10⁹ to 2×10⁹ N/m² or 2×10⁹ to 10× 10⁹ N/m².

Polycarbonate can have a longitudinal velocity of sound of 2,300 meters per second (m/s), a shear wave sound velocity value of 1,250 m/s, and an acoustic impedance value of 2.75 megaRayleighs (MRayl), where one Rayleigh is equivalent to 1 kilogram per square meter second (kg/m²s). Air has a longitudinal velocity of sound of 334 m/s. Thermoplastic resins can have a longitudinal velocity of sound of 1,600 to 2,800 m/s; a shear wave sound velocity of 500 to 1,600 m/s; and an acoustic impedance value of 1.5 to 3 MRayl. Liquids can have a longitudinal velocity of sound of 750 to 1,500 m/s and an acoustic impedance of 0.8 to 1.5 MRayl.

The first layer can further include a reinforcement material, for example, glass, plastic (e.g., thermoplastic polymer, thermoset polymer), or a combination thereof, such as high stiffness fibers (e.g., glass). High stiffness refers to a tensile modulus of greater than or equal to 35 gigapascals (GPa). For example, the fibers can be formed of liquid crystal polymer, high tenacity polymer (e.g., polypropylene, polyethylene, poly(hexano-6-lactam), poly[imino (1,6-dioxohexamethylene)iminohexamethylene]), or a combination thereof. An exemplary fiber filled resin is Lexan* resin, commercially available from SABIC Innovative Plastics. Another exemplary fibrous material can include fiber reinforced thermoplastics such as Ultem* resins, commercially available from SABIC Innovative Plastics). Reinforcement fibers including E-glass. S-glass or a combination thereof, can be employed.

Composites including a reinforcement material such as glass can be used to provide desirable density in the first layer. The density of the first layer contributes to the differing densities of the multiple layers of different materials that can provide desirable sound insulation properties in the multimaterial sheet.

### Second Layer

The second layer (20) includes a second plastic, glass, ceramic, or a combination thereof. The second layer (20) has a density of 800-5,000 kg/m³.

In an aspect, the second layer (20) includes the second plastic. The second plastic can include a material, e.g., polycarbonate, as described herein for the first plastic. In an aspect, the second plastic, e.g., polycarbonate, is the same as the first plastic, e.g., polycarbonate. In an aspect, the second plastic is different than the first plastic. The second layer (20) including plastic can have a thickness of 8 to 15 mm, or 8.5 to 14 mm, or 9 to 13 mm.

In an aspect, the second layer (20) includes glass. The second layer (20) including glass can have a thickness of 0.1 to 10 mm, or 1 to 5 mm, or 2 to 4 mm. When including a relatively higher density material such as glass, the second layer (20) can have a thinner thickness than when the second layer (20) include a relatively lower density material such as plastic.

The second layer can have a nanocellular morphology (also referred to herein as a “nanofoam”). As used herein, the phrase “nanocellular morphology” is defined as an average pore cell size (as measured along a major diameter) of less than 1 micrometer, and having a cell density of greater than or equal to 10¹² cells per cubic centimeter (cells/cm³). For example, the nanocellular morphology can have an average pore cell size of 1 nanometers (nm) to 780 nm, or 10 to 380 nm, 10 to 200 nm, or 1 to 10 nm. The number of cells per cubic centimeter is the cell density, which can be greater than or equal to 10¹² cells/cm³, or 10¹² to 10²² cells/cm³, 10¹² to 10²² cells/cm³, 10¹⁵ to 10²² cells/cm³, or 10¹⁸ to 10²² cells/cm³.

To form nanocellular morphology, a diffused blowing agent content in the polymer composition (i.e., the polymer and the blowing agent cage material) can be greater than or equal to 15% gain by weight of carbon dioxide, or greater than or equal to 20% gain by weight of carbon dioxide, greater than or equal to 30%, or greater than or equal to 35% gain by weight of carbon dioxide at room temperature and 60 bar pressure.

The polymer can include those that have an affinity for carbon dioxide. An advantage of nanocellular morphology can be its transparency, and a transparent polymer can be used. Some exemplary polymers can include thermoplastics such as polyalkylenes (e.g., polyethylene, polypropylene, polyalkylene terephthalates (such as polyethylene terephthalate, polybutylene terephthalate)), polycarbonates, acrylics, polyacetals, styrenes (e.g., impact-modified polystyrene, acrylonitrile-butadiene-styrene, styrene-acrylonitrile), poly(meth)acrylates (e.g., polybutyl acrylate, polymethyl methacrylate), polyetherimide, polyurethanes, polyphenylene sulfides, polyvinyl chlorides, polysulfones, polyetherketones, polyether etherketones, polyether ketone ketones, or a combination thereof. Exemplary thermoplastic combinations include acrylonitrile-butadiene-styrene/nylon, polycarbonate/acrylonitrile-butadiene-styrene, acrylonitrile butadiene styrene/polyvinyl chloride, polyphenylene ether/polystyrene, polyphenylene ether/nylon, polysulfone/acrylonitrile-butadiene-styrene, polycarbonate/thermoplastic urethane, polycarbonate/polyethylene terephthalate, polycarbonate/polybutylene terephthalate, thermoplastic elastomer alloys, nylon/elastomers, polyester/elastomers, polyethylene terephthalate/polybutylene terephthalate, acetal/elastomer, styrene-maleic anhydride/acrylonitrile-butadiene-styrene, polyether etherketone/polyethersulfone, polyethylene/nylon, or polyethylene/polyacetal. In an aspect, a polycarbonate, such as those designated by the trade name Lexan*, which are commercially available from the SABIC Innovative Plastics, can be employed as the polymer.

### Space Between First and Second Layers

The second layer (20) can be spaced apart (15) from the first layer (10) by, i.e., a distance between the first layer (10) and the second layer (20) along the y-axis can be, 50 to 100 mm, or 55 to 90 mm, or 60 to 80 mm.

The space (15) between the first layer (10) and the second layer (20) can include, for example, a gas (such as air or an inert gas), a vacuum, an aerogel, a nanofoam, or a multiwall sheet. In an aspect, an air gap (15) separates the first layer (10) and the second layer (20) and the density of the air gap (15) can be in the range of 1 to 2 kg/m³, for example, 1.226 kg/m³ (air).

In an aspect, the space between the first layer and the second layer includes a nanofoam. The nanofoam can include a material as described herein for the second layer. In an aspect, the nanofoam present between the first layer and the second layer is the same as the nanofoam of the second layer. In an aspect, the nanofoam present between the first layer and the second layer is different than the nanofoam of the second layer.

Examples of aerogels that can be included between the first layer and the second layer include a silicon dioxide aerogel or an organic polymer aerogel, or a carbon aerogel. The porosity and particle size that are critical for the release characteristics can be tuned by the selection of process parameters conditions (e.g., acid-base catalysis, surfactants, type of silicon precursors, temperature, time, and mixing conditions) employed to make the aerogel. An aerogel is an open-celled, mesoporous, solid foam that is composed of a network of interconnected nanostructures and that exhibits a porosity (non-solid volume) of no less than 80%. The pores can have a diameter in the range of, for example, 1 to 100 nm of 1 to 20 nm.

In an aspect, the space between the first layer and the second layer includes a multiwall sheet. The multiwall sheet can have a thickness along the y-axis of 6 to 60 mm, for example, 7 to 50 mm or 8 to 40 mm. The multiwall sheet can include at least two walls, for example, threes walls, five walls, or nine walls. As shown in FIG. 5, the multiwall sheet can include two walls with ribs extending between the walls.

As shown in FIG. 6, the multiwall sheet can include two outer walls, one transverse wall, and ribs extending between the walls. The transverse wall can extend longitudinally the length of the walls (e.g., between the walls). In an aspect, the transverse wall can be parallel to the walls, or the transverse wall can be substantially parallel to the walls (e.g., not completely parallel across the entire length of the walls, but also not intersecting the walls, accommodating for slight variations in the orientation during processing). The multiwall sheet of FIG. 6 further includes dividers, which are located between the traverse wall and the outer walls. The dividers are non-parallel and non-perpendicular to the walls and the ribs. The dividers of FIG. 6 form an “X” shape.

As shown in FIG. 7, the multiwall sheet can include two outer walls, one transverse wall, and ribs extending between the walls. As shown in FIG. 8, the multiwall sheet can include two outer walls, four transverse wall, and ribs extending between the walls. The multiwall sheet of FIG. 8 further includes dividers, which are located between the traverse wall and the outer walls

As shown in FIG. 9, the multiwall sheet can include two outer walls, three transverse walls, and ribs extending between the walls. As shown in FIG. 10, the multiwall sheet can include two outer walls, three transverse walls, and ribs extending between the walls. The multiwall sheet of FIG. 10 further includes dividers, which are located between the traverse wall and the outer walls (e.g., “X” shaped dividers). As shown in FIG. 11, the multiwall sheet can include two outer walls, three transverse walls, ribs extending between the walls, and dividers forming a different pattern than shown in FIG. 10.

The multiwall sheet can have sinusoidal shaped dividers. It is contemplated that any suitable shape dividers could be used. For example, the dividers can include a shape such as lamellar-shaped elements, triangular-shaped elements, pyramidal-shaped elements, cylindrical-shaped elements, conical-shaped elements, cubical-shaped elements, trapezoidal-shaped elements, sinusoidal-shaped elements, saw tooth-shaped elements, abs (sin)-shaped elements, cycloid-shaped elements, fiber shaped elements, or a combination thereof.

### Third Layer

The third layer (30) includes a multiwall sheet and having a density of 50-250 kg/m³, or 60-200 kg/m³. A thickness of the third layer (30) along the y-axis can be 3 to 25%, or 4 to 20% or 5 to 15%, of the distance between the first layer (10) and the second layer (20) along the y-axis. In an aspect, the thickness of the third layer (30) along the y-axis (t₃₀) is 6 to 60 mm, for example, 7 to 50 mm or 8 to 40 mm.

The third layer (30) including a multiwall sheet structure, as described herein that can be present between the first layer (10) and the second layer (20). In an aspect, the structure, thickness along the y-axis, or a combination thereof of the multiwall sheet of the third layer (30) is the same as that of the multiwall sheet present between the first layer (10) and the second layer (20). In an aspect, the structure, thickness along the y-axis, or a combination thereof of the multiwall sheet of the third layer (30) is different than that of the multiwall sheet present between the first layer (10) and the second layer (20).

The multiwall sheet can have an equivalent density of 50-250 kg/m³, or 60-200 kg/m³, defined as, total weight of the multiwall sheet in kg divided by total volume in m³. The material of construction of internal elements (e.g., skins, ribs, etc.) of the multiwall sheet can have a density of 800-2,000 kg/m³, for example, about 1,200 kg/m³.

The multiwall sheet can be a thermoplastic resin, thermoset, or a combination thereof. Possible thermoplastic resins that can be employed include, but are not limited to, oligomers, polymers, ionomers, dendrimers, copolymers such as graft copolymers, block copolymers (e.g., star block copolymers, random copolymers, etc.), or a combination thereof. Examples of such thermoplastic resins include, but are not limited to, polycarbonates (e.g., blends of polycarbonate (such as, polycarbonate-polybutadiene blends, copolyester polycarbonates)), polystyrenes (e.g., copolymers of polycarbonate and styrene, polyphenylene ether-polystyrene blends), polyimides (e.g., polyetherimides), acrylonitrile-styrene-butadiene (ABS), polyalkylmethacrylates (e.g., polymethylmethacrylates), polyesters (e.g., copolyesters, polythioesters), polyolefins (e.g., polypropylenes and polyethylenes, high density polyethylenes, low density polyethylenes, linear low density polyethylenes), polyamides (e.g., polyamideimides), polyarylates, polysulfones (e.g., polyarylsulfones, polysulfonamides), polyphenylene sulfides, polytetrafluoroethylenes, polyethers (e.g., polyether ketones, polyether etherketones, polyethersulfones), polyacrylics, polyacetals, polybenzoxazoles (e.g., polybenzothiazinophenothiazines, polybenzothiazoles), polyoxadiazoles, polypyrazinoquinoxalines, polypyromellitimides, polyquinoxalines, polybenzimidazoles, polyoxindoles, polyoxoisoindolines (e.g., polydioxoisoindolines), polytriazines, polypyridazines, polypiperazines, polypyridines, polypiperidines, polytriazoles, polypyrazoles, polypyrrolidines, polycarboranes, polyoxabicyclononanes, polydibenzofurans, polyphthalides, polyacetals, polyanhydrides, polyvinyls (e.g., polyvinyl ethers, polyvinyl thioethers, polyvinyl alcohols, polyvinyl ketones, polyvinyl halides, polyvinyl nitriles, polyvinyl esters, polyvinylchlorides), polysulfonates, polysulfides, polyureas, polyphosphazenes, polysilazzanes, polysiloxanes, or a combination thereof.

In an aspect, multiwall sheet can include, but is not limited to, polycarbonate resins (e.g., Lexan* resins, commercially available from SABIC Innovative Plastics), polyphenylene ether-polystyrene resins (e.g., Noryl* resins, commercially available from SABIC Innovative Plastics), polyetherimide resins (e.g., Ultem* resins, commercially available from SABIC Innovative Plastics), polybutylene terephthalate-polycarbonate resins (e.g., Xenoy* resins, commercially available from SABIC Innovative Plastics), copolyestercarbonate resins (e.g. Lexan* SLX resins, commercially available from SABIC Innovative Plastics), or a combination thereof. In an aspect, the thermoplastic resins can include, but are not limited to, homopolymers and copolymers of a polycarbonate, a polyester, a polyacrylate, a polyamide, a polyetherimide, a polyphenylene ether, or a combination thereof. The polycarbonate can include copolymers of polycarbonate (e.g., polycarbonate-polysiloxane, such as polycarbonate-polysiloxane block copolymer), linear polycarbonate, branched polycarbonate, end-capped polycarbonate (e.g., nitrile end-capped polycarbonate), or a combination thereof, for example, a combination of branched and linear polycarbonate. In an aspect, the multiwall sheet can include polycarbonate (e.g., Lexan* Thermoclear* Sheet LT2UV102RS17).

### Fourth Layer

The fourth layer (40) includes a third plastic and has a density of 800-2,000 kg/m³. A thickness of the fourth layer (40) along the y-axis can be 8 to 15 mm, or 8.5 to 14 mm, or 9 to 13 mm.

The fourth plastic can include a material, e.g., polycarbonate, as described herein for the first plastic. In an aspect, the fourth plastic, e.g., polycarbonate, is the same as the first plastic, e.g., polycarbonate. In an aspect, the fourth plastic is different than the first plastic.

The multimaterial sheet can further include an adhesive layer between the second layer (20) and the third layer (30); an adhesive layer between the third layer (30) and the fourth layer (40); or an adhesive layer, e.g., a first adhesive layer, between the second layer (20) and the third layer (30) and an adhesive layer, e.g., a second adhesive layer, between the third layer (30) and the fourth layer (40). In an aspect, the second layer (20) can be mechanically secured to the third layer (30) at support ends thereof; the third layer (30) can be mechanically secured to the fourth layer (40) at support ends thereof; or a combination thereof.

In an aspect, the first layer (10) includes a projection, for example, to match a shape of a metallic roof corrugation channel. The projection can have a cross-sectional shape of, for example, a trapezoid or other shape similar to metallic roof corrugation channels.

In an aspect, the projection can have a smallest width of 10 to 100 mm, or 20 to 50 mm or 25 to 35 mm; a largest width of 50 to 100 mm, or 60 to 80 mm or 65 to 75 mm; a height of 10 to 100 mm, or 30 to 50 mm, or 35 to 45 mm; or a combination thereof.

With reference to FIG. 3, the disclosed multimaterial sheet includes a first layer (10) including a first plastic; a second layer (20) including a second plastic, glass, ceramic, or a combination thereof, the second layer (20) being spaced apart (15) from the first layer (10); a third layer (30) including a multiwall sheet; and a fourth layer (40) including a third plastic. As shown in FIG. 3, the first layer (10), the second layer (20), the third layer (30), and the fourth layer (40) are stacked along a y-axis. The first layer (10) includes a trapezoidal shaped projection (12). Transmission loss and STL for the multimaterial sheet illustrated in FIG. 3 are provided in Example 1 and FIG. 4.

In an aspect, a method of sound insulating a structure can include forming a multimaterial sheet as described herein and attaching the multimaterial sheet to the structure. Formation of the multimaterial sheet can be determined based on a degree of sound insulation desired in an area of the structure.

The width of the multimaterial sheet measured in the z-axis direction can provide sufficient spatial area coverage for the intended use (e.g., as a roofing, sheeting, or similar products). The length of the multimaterial sheet measured in the x-axis direction can provide sufficient stiffness for the intended use (e.g., as a roofing, sheeting product, or similar product).

Optionally, the multimaterial sheet can additionally include a clip located at an end of the multimaterial sheet to facilitate attachment to a structure, frame enclosure for the multimaterial sheet, or to another multimaterial sheet. The multimaterial sheet can, optionally, include a receiving end for a clip to attach thereto.

Different visual effects can be created by using a colored layer. For example, one or more different colored layers can be included, creating different visual effects. In an aspect, one or more of the layers can be transparent (e.g., at least 85% transparent), while one or more layers can be opaque or translucent.

When assembled, the multimaterial sheet can be exposed to a variety of forces caused by snow, wind, rain, hail, and the like. The multimaterial sheet is desirably capable of withstanding these forces without failing (e.g., buckling, cracking, bowing, and so forth). The specific dimensions of the multimaterial sheet can be chosen so that the multimaterial sheet can withstand these forces.

STL can be predicted using numerical prediction of acoustic performance of multimaterial sheet using prediction software, e.g., COMSOL Multiphysics software. Sound transmission class can be calculated according to ASTM E413-2016, while the sound reduction index (Rw) can be calculated according to ISO 717-DIN 52210. These standards can be used to rate partitions, doors, windows, and roofs for their effectiveness in blocking sound.

Such a multimaterial sheet as disclosed herein can provide an overall best performance and low cost product for sound insulation. The multimaterial sheet can be easy to install. The multimaterial sheets disclosed herein can be used in a variety of applications, including, but not limited to, industrial roof and sidewalls, commercial greenhouses, sunroom, swimming pool, and conservatory roofing, shopping center roofing, railway/metro stations, football stadium roofing, and roof lights.

The following examples are merely illustrative of the device disclosed herein and are not intended to limit the scope hereof. All of the following examples were based upon simulations unless specifically stated otherwise.

### EXAMPLES

In the Examples, Sound Transmission Loss (STL)/Sound Transmission Class (STC)/Weighted Sound Reduction Index (Rw) is determined by comparing a simulated transmission loss curve of an acoustic product using COMSOL Multiphysics software with a set of ASTM/ISO standard curves. A standard curve that meets the criteria that the sum of the deviations of the standard and simulated curves is not greater than 32 dB, and according to ISO, deviation at any frequency is not more than 8 dB, is determined. The value at 500 Hz of the standard curve that meets the criteria is the single-number quantity STL/STC/Rw rating.

### Example 1

An STL predicted value of the multimaterial sheet illustrated in FIG. 1 was determined. The multimaterial sheet included a first layer of a transparent composite having a thickness of 2.1 millimeters (mm); a second layer of glass having a thickness of 2 mm or 3 mm; an air gap having a thickness 69-70 mm between the first layer and the second layer; a third layer of a two wall multimaterial sheet having a thickness of 10 mm (Lexan* Thermoclear* Sheet LT2UV102RS17, equivalent density 170 kg/m³); and a fourth layer of solid polycarbonate.

FIG. 2 includes an STL predicted value by ASTM/ISO standard (solid line) and STL simulated values using the COMSOL Multiphysics software (dotted lines) for the multimaterial sheet. In FIG. 2, for the multimaterial sheet illustrated in FIG. 1, the predicted STL predicted value is greater than 50 decibels (dB) at 500 Hz (for the 2 mm second layer of glass and the 3 mm second layer of glass).

### Example 2

An STL predicted value of the multiwall sheet illustrated in FIG. 3 was determined. The multimaterial sheet included a first layer of a transparent composite having a thickness of 2.1 mm; a second layer of solid polycarbonate having a thickness of 9.5 mm; an air gap having a thickness 68.9 mm between the first layer and the second layer; a third layer of a two wall multiwall sheet having a thickness of 10 mm (Lexan* Thermoclear* Sheet LT2UV102RS17, equivalent density 170 kg/m³); and a fourth layer of solid polycarbonate having a thickness of 9.5 mm. The multimaterial sheet included a projection having a cross-sectional shape of a trapezoid having a smallest width of 30 mm, a largest width of 70 mm, and a height of 40 mm.

FIG. 4 includes an STL predicted value by ASTM/ISO standard (solid line) and STL simulated values using the COMSOL Multiphysics software (dotted line) for the multimaterial sheet. In FIG. 4, for the multimaterial sheet illustrated in FIG. 3, the predicted STL predicted value is greater than 50 decibels (dB) at 500 Hz.

In an aspect, a multimaterial sheet, comprises a first layer (10) comprising a first plastic and having a density of 2,000-5,000 kilograms per cubic meter; a second layer (20) comprising a second plastic, glass, ceramic, or a combination thereof and having a density of 800-5,000 kilograms per cubic meter, wherein the second layer (20) is spaced apart (15) from the first layer (10); a third layer (30) comprising a multiwall sheet and having a density of 50-250 kg/m³, or 60-200 kilograms per cubic meter; and a fourth layer (40) comprising a third plastic and having a density of 800-2,000 kilograms per cubic meter, wherein the first layer, the second layer, the third layer, and the fourth layer are stacked along a y-axis.

In an aspect, the second layer comprises the second plastic and has a thickness of 8 to 15 millimeters, or 8.5 to 14 millimeters or 9 to 13 millimeters;
the second layer comprises glass and has a thickness of 0.1 to 10 millimeters, or 1 to 5 millimeters or 2 to 4 millimeters; a total thickness of the multimaterial sheet along the y-axis is 10 to 1,000 millimeters, or 25 to 500 millimeters or 50 to 100 millimeters; a thickness of the first layer along the y-axis is 0.1 to 25 millimeters, or 1 to 10 millimeters or 1 to 3 millimeters; a distance between the second layer and the first layer along the y-axis is 50 to 100 millimeters, or 55 to 90 millimeters or 60 to 80 millimeters; a thickness of the third layer along the y-axis is 3 to 25%, or 4 to 20% or 5 to 15%, of the distance between the second layer and the first layer along the y-axis; the thickness of the third layer along the y-axis is 6 to 60 millimeters, for example, 7 to 50 millimeters or 8 to 40 millimeters; a thickness of the fourth layer along the y-axis is 8 to 15 millimeters, or 8.5 to 14 millimeters or 9 to 13 millimeters; a sound transmission loss of the multimaterial sheet is greater than 50 decibels, or greater than 51 decibels or greater than 52 decibels, as specified by ASTM E413-16; the multiwall sheet of the third layer comprises two walls; the multimaterial sheet further comprises a multiwall sheet between the first layer and the second layer; an air gap separates the second layer and the first layer; the multimaterial sheet further comprises an adhesive layer between the second layer and the third layer, an adhesive layer between the third layer and the fourth layer, or a first adhesive layer between the second layer and the third layer and a second adhesive layer between the third layer and the fourth layer; and/or the first layer comprises a projection.

All ranges disclosed herein are inclusive of the endpoints, and the endpoints are independently combinable with each other (e.g., ranges of “up to 25 wt. %, or, for example, 5 wt. % to 20 wt. %”, is inclusive of the endpoints and all intermediate values of the ranges of “5 wt. % to 25 wt. %,” etc.). “Combination” is inclusive of blends, mixtures, alloys, reaction products, and the like. Furthermore, the terms “first,” “second,” and the like, herein do not denote any order, quantity, or importance, but rather are used to determine one element from another. The terms “a” and “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the film(s) includes one or more films). Reference throughout the specification to “an aspect” means that a particular element (e.g., feature, structure, and/or characteristic) described in connection with the aspect is included in at least one aspect described herein, and may or may not be present in other aspects. In addition, it is to be understood that the described elements may be combined in any suitable manner in the various aspects.

Exemplary aspects are described herein with reference to cross section illustrations that are schematic illustrations of idealized aspects. As such, variations from the shapes of the illustrations as a result, for example, of manufacturing techniques and/or tolerances, are to be expected. Thus, aspects described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Unless specified to the contrary herein, all test standards are the most recent standard in effect as of the filing date of this application, or, if priority is claimed, the filing date of the earliest priority application in which the test standard appears.

1. A multimaterial sheet, comprising:
a first layer (10) comprising a first plastic and having a density of 2,000-5,000 kilograms per cubic meter;
a second layer (20) comprising a second plastic, glass, ceramic, or a combination thereof and having a density of 800-5,000 kilograms per cubic meter, wherein the second layer (20) is spaced apart (15) from the first layer (10);
a third layer (30) comprising a multiwall sheet and having a density of 50-250 kilograms per cubic meter; and
a fourth layer (40) comprising a third plastic and having a density of 800-2,000 kilograms per cubic meter,
wherein the first layer, the second layer, the third layer, and the fourth layer are stacked along a y-axis.

2. The multimaterial sheet of claim 1, wherein the second layer comprises the second plastic and has a thickness of 8 to 15 millimeters.

3. The multimaterial sheet of claim 1, wherein the second layer comprises glass and has a thickness of 0.1 to 10 millimeters.

4. The multimaterial sheet of claim 1, wherein a total thickness of the multimaterial sheet along the y-axis is 10 to 1,000 millimeters.

5. The multimaterial sheet of claim 1, wherein a thickness of the first layer along the y-axis is 0.1 to 25 millimeters.

6. The multimaterial sheet of claim 1, wherein a distance between the second layer and the first layer along the y-axis is 50 to 100 millimeters.

7. The multimaterial sheet of claim 6, wherein a thickness of the third layer along the y-axis is 3 to 25% of the distance between the second layer and the first layer along the y-axis.

8. The multimaterial sheet of claim 7, wherein the thickness of the third layer along the y-axis is 6 to 60 millimeters.

9. The multimaterial sheet of claim 1, wherein a thickness of the fourth layer along the y-axis is 8 to 15 millimeters.

10. The multimaterial sheet of claim 1, wherein a sound transmission loss of the multimaterial sheet is greater than 50 decibels, as specified by ASTM E413-16.

11. The multimaterial sheet of claim 1, wherein the multiwall sheet of the third layer comprises two walls.

12. The multimaterial sheet of claim 1, further comprising a multiwall sheet between the first layer and the second layer.

13. The multimaterial sheet of claim 1, wherein an air gap separates the second layer and the first layer.

14. The multimaterial sheet of claim 1, further comprising
an adhesive layer between the second layer and the third layer;
an adhesive layer between the third layer and the fourth layer; or
a first adhesive layer between the second layer and the third layer and second adhesive layer between the second layer and the third layer.

15. The multimaterial sheet of claim 1, wherein the first layer comprises a projection.
